(19) United States
(12) Patent Application Publication
(10) Pub. No.: US 2006/0036395 A1
(43) Pub. Date: Feb. 16, 2006

(54) Method and apparatus for measuring and controlling food intake of an individual

(76) Inventors: Steven A. Shaya, Highlands, NJ (US); Leona Brenner-Gati, Princeton Junction, NJ (US); John Cronin, Jericho, VT (US); Nancy Drehwing Edwards, Jericho, VT (US); Douglas J. Roth, Essex, VT (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/181,426

(22) Filed: Jul. 13, 2005

Related U.S. Application Data
(60) Provisional application No. 60/592,919, filed on Jul. 30, 2004.

(51) Int. Cl. G06F 15/00

(52) U.S. Cl. 702/127

(57) ABSTRACT

Provided herein is a method for monitoring dietary intake of food items. The method involves the steps of selecting a portion of food, weighing the portion, inputting the type and weight amount of the food into a computer, and obtaining the caloric content of the food by from a database. There is also provided an apparatus for monitoring dietary intake of food items. The apparatus includes a means for weighing a preselected portion of food, a computer for inputting the type and weight amount of the food therein, and a database operatively associated with the computer for obtaining the caloric content of the food.

### CROSS REFERENCE TO RELATED APPLICATIONS

This application claims the benefit of U.S. Provisional Application Ser. No. 60/592,919 entitled “A METHOD AND APPARATUS FOR MEASURING AND CONTROLLING FOOD INTAKE OF AN INDIVIDUAL” to Shay, filed 30 Jul. 2004.

### FIELD OF THE INVENTION

The present invention relates in general to methods and apparatuses for measuring caloric or other nutritional component intake of an individual.

### BACKGROUND OF THE INVENTION

The percentage of the world's population suffering from obesity is steadily increasing. Severely obese persons are susceptible to increased risk of heart disease, stroke, diabetes, pulmonary disease, and accidents. Because of the effect of morbid obesity to the life of the patient, methods of treating morbid obesity are being researched.

Numerous non-operative therapies for morbid obesity have been tried with virtually no permanent success. Dietary counseling, behavior modification, wiring a patient's jaws shut, and pharmacological methods have all been tried, and failed to correct the condition. Mechanical apparatuses for insertion into the body through non-surgical means, such as the use of gastric balloons to fill the stomach have also been employed in the treatment of the condition. Such devices cannot be employed over a long term, however, as they often cause severe irritation, necessitating their periodic removal and hence interruption of treatment. Thus, the medical community has evolved surgical approaches for treatment of morbid obesity. Dieting and diet pills are used repeatedly by the obese in part because these programs are generally unsuccessful and consumers relapse.

The failure of the non-operative approaches may lay in the difficulties in knowing and keeping track of accurate food consumption parameters that have a direct bearing on caloric and other nutritional component consumption, but also pertains to other nutritional components such as fat content, salt levels, etc. Accurate portion monitoring is a key variable in weight management and diabetic glycemia management programs. Real time portion feedback is a new way for dieters to take-more than they need to eat, but get information and signals as they eat that their limits have been met. Once there is a measure of caloric intake, there is a need to correlate this with the dependent variables, weight and blood glucose readings, also integrating data on the other independent variables, caloric expenditure data or exercise records, drug dosing, illness, stress, and so forth. That is to say, a management system is empowered once there is access to detailed and accurate dietary data at the level of average daily intake plots, breakouts by meals, day of the week, and, if necessary, the ability to dive down to the food components of out of limits meals. The algorithms used to drive insulin pump delivery require blood glucose and would be improved by addition of caloric or carbohydrate intake as an independent parameter. This device provides timed caloric intake accurate to about 10 seconds. (The uncertainty between time of lifting a bit of food from the plate and ingesting it.) No previous device addresses this need prior to this invention. While caloric content of food is commonly utilized for rational management of weight, other nutritional components of consumed food are of value in a range of medical conditions. These include carbohydrates, fats or lipids, saturated or unsaturated fatty acids, sodium, protein, dietary fiber, sugar, calcium, iron, and various vitamins. All of these can be tracked in a way similar to calories by this invention. In the following, where calories are described as the subject of monitoring, it is understood users could be monitoring other nutritional components, multiple nutritional components or properties, or parameters that are a combination of multiple food parameters. The communication of these data can be numerical, relative to personal targets, or qualitative, as in a good/bad, healthy/unhealthy, green light/red light or similar qualitative communication.

Weight management programs utilize data entry formats (food consumption logs) for the energy input side of the balance against energy utilization. This is awkward, relies on memory, involves estimates of quantities that many people have no comprehension for, and is often subject to biased estimations. Even a crude input of all factors involved in diabetic management provides a platform for more informed patient management. The consideration of all components impacting the patient outcomes is appreciated by the patient. This data provides the professional with a picture of the lifestyle management challenges. At this time, the outcome drivers, food and exercise, are poorly measured. We are seeking ways to upgrade this glaring inadequacy. What is needed is a way to help manage dietary intake important to diabetics, overweight, underweight, geriatric, pregnant and people managing their weight and other health problems for a variety of reasons.

### BRIEF SUMMARY OF THE INVENTION

Provided herein is an apparatus for and method of monitoring dietary intake of food items. The apparatus includes a means for weighing a pre-selected portion of food, a computer for inputting the type and accepting the weighed amount of the food, further having a database operatively associated with the computer for obtaining the caloric or nutrient content of the actual amount of each food type consumed, and a display and keyboard designed to interact with the computer and database to use the apparatus.

The apparatus weighs portions and tracks either changes in weight of foods as they are consumed, or alternatively the weight of the residual foods (“leftovers”) at the end of a meal.

There is also provided a method for monitoring dietary intake of food items utilizing the apparatus. The method involves the steps of selecting a portion of food, weighing the portion, inputting the type and weighed amount of the food into a computer, and obtaining the caloric content of the food from a database.

### BRIEF DESCRIPTION OF THE FIGURES

FIG. 1 is a high-level diagram of a real-time calorie counting system 100.

FIGS. 2A and 2B are detailed functional block diagrams of real-time calorie counting system 100.

FIGS. 3A and 3B illustrate weight sensor 50 and weight sensor subsystem 55.

FIG. 3C is a top view of real-time calorie counting system 100 including the interactive display, made in accordance with the present invention.

FIG. 3D is a cross section of the real time calorie counting system 100 shown in FIG. 3C.

FIG. 4 illustrates a flow diagram of a method 400 for operating real-time calorie counting system 100.

FIG. 5 illustrates a flow diagram of a method 500 for calculating the caloric content of a food item.

FIG. 6 is a method of determining calorie content of a homemade recipe.

### DETAILED DESCRIPTION OF THE INVENTION

The present invention is an apparatus and method for monitoring dietary intake of food items, including operational systems and algorithms to accomplish this, and business methods that employ this apparatus.

The apparatus monitors and tracks energy input or other nutritive components for a user. The user enters the identity of each kind of food being consumed using any of a variety of search methods. The identity of food can also be automatically determined by a bar code reader to read packaging product identification. The weight of a food consumed is logged into a computer by any of a variety of modes: direct entry, weighing of foodstuff portions, or by weighing of foodstuff actually consumed. The latter is accomplished in one of two ways: 1) the multiple food items that have been plated are selectable by the dieter (by touch screen on their identifiers or a dropdown menu, etc.) while that food item is being consumed and continuously weighed, allowing real-time display of calories consumed; or 2) the leftover portions of each food item is designated, removed, and that weight discounted from the portion of that food item initially ascertained. The apparatus has and a display, which displays the calories of food portions as they are added to a plate and/or while food is being consumed. These real-time readings may then be displayed along with the deviation from personal caloric intake targets for each meal and/or the whole day. Thereafter the over/under target differences may also displayed. This real time display and signaling provides dieters the information they need to eat responsibly. This device records the identity of each food, the weight consumed, the caloric content consumed, and the time of consumption for a variety of dietary analyses as well as downloading of this data for external analyses.

A method of tracking accurate caloric intake by weighing food portions, identifying the food item, and having the device automatically multiply the specific energy by the weight of food to keep records of that intake is also provided and described herein. In addition, there is provided herein a method to display the running caloric intake as food is removed from a plate spoonful by spoonful. These methods may also involve the step of displaying the deviation of the real time or portioned food intake against daily and meal targets.

Real Time Calorie Counting System

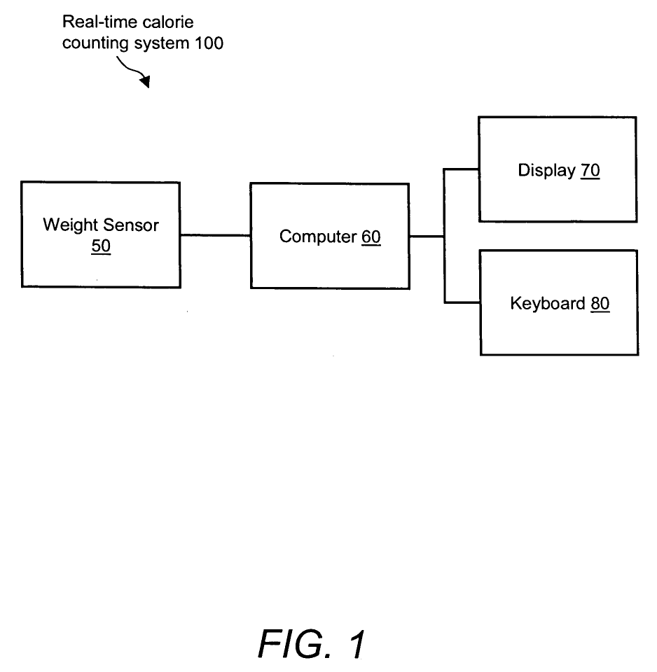

FIG. 1 is a high-level diagram of a real-time calorie counting system 100, including a weight sensor 50, a computer 60, a display 70, and an input device, such as a keyboard 80.

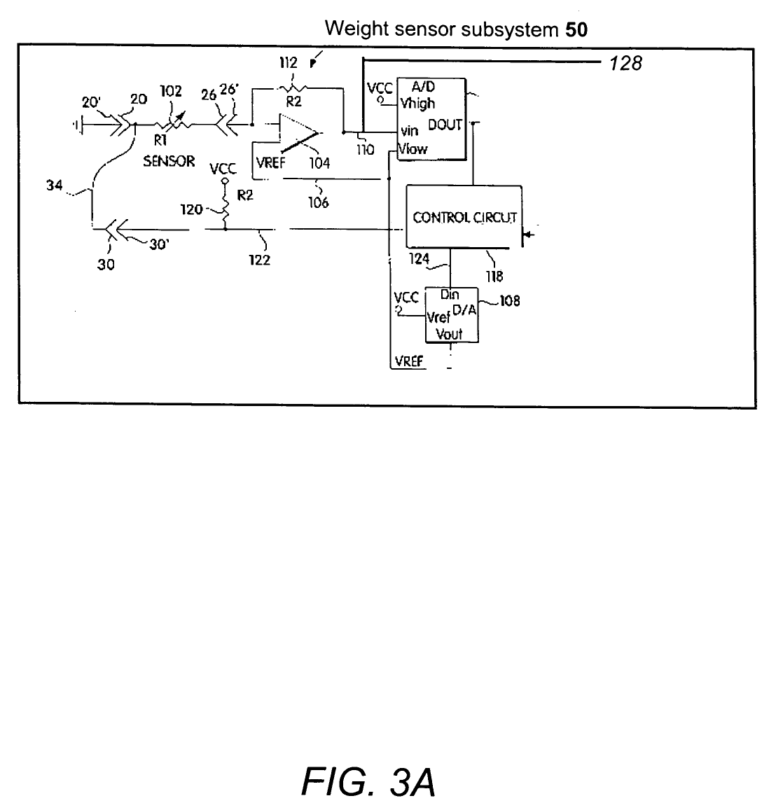

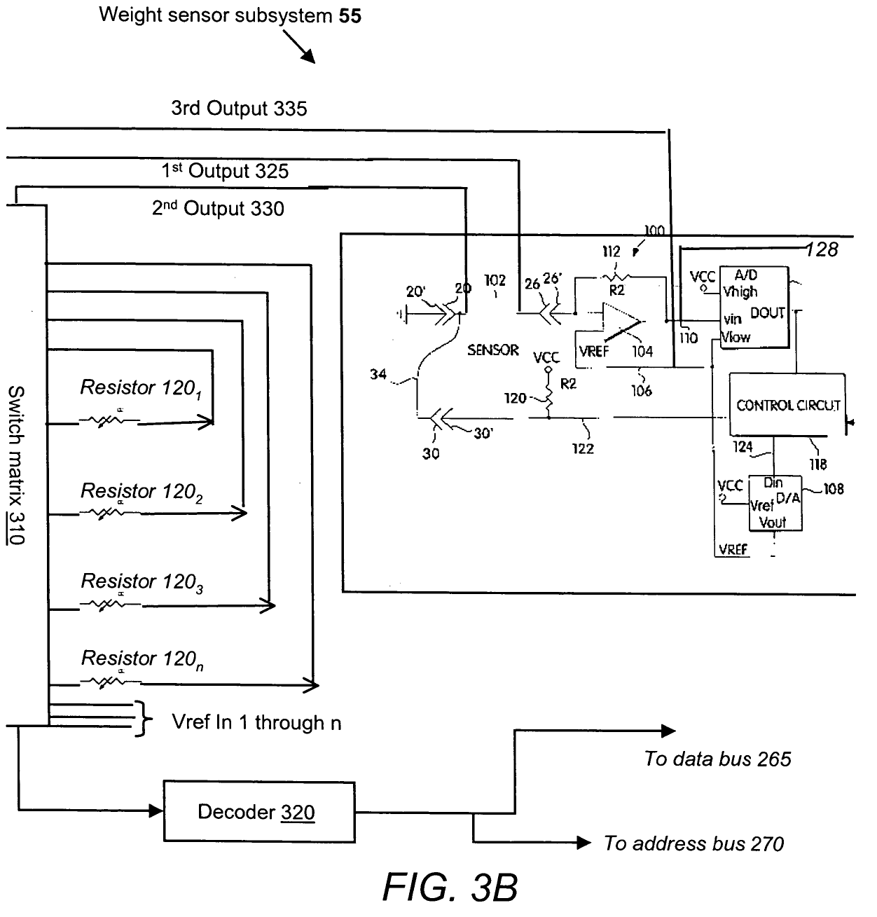

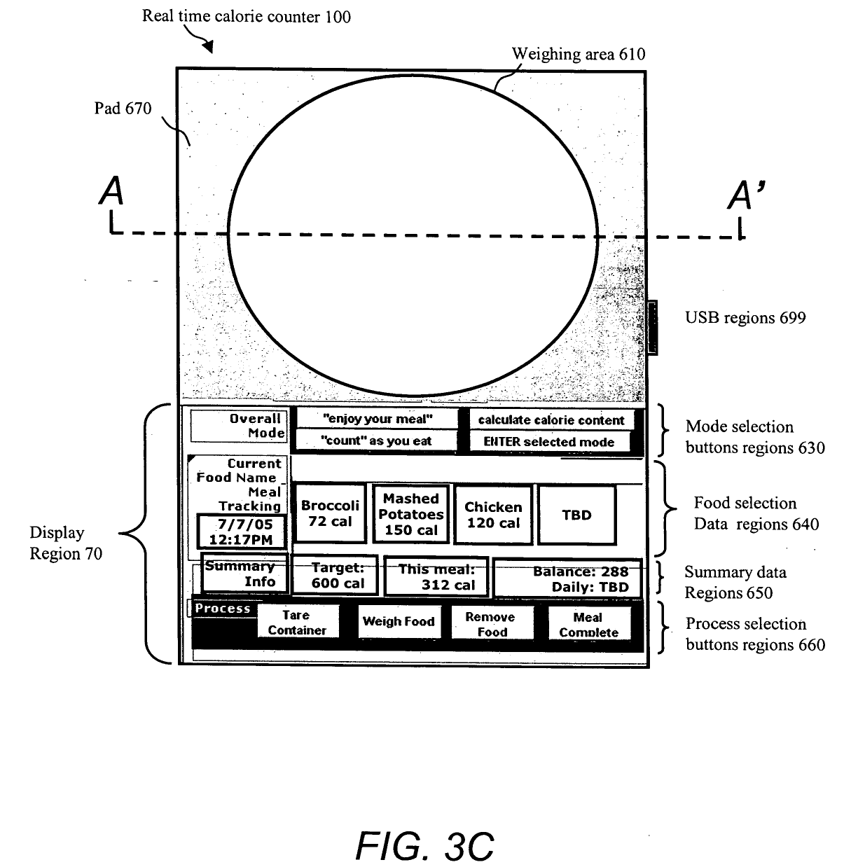

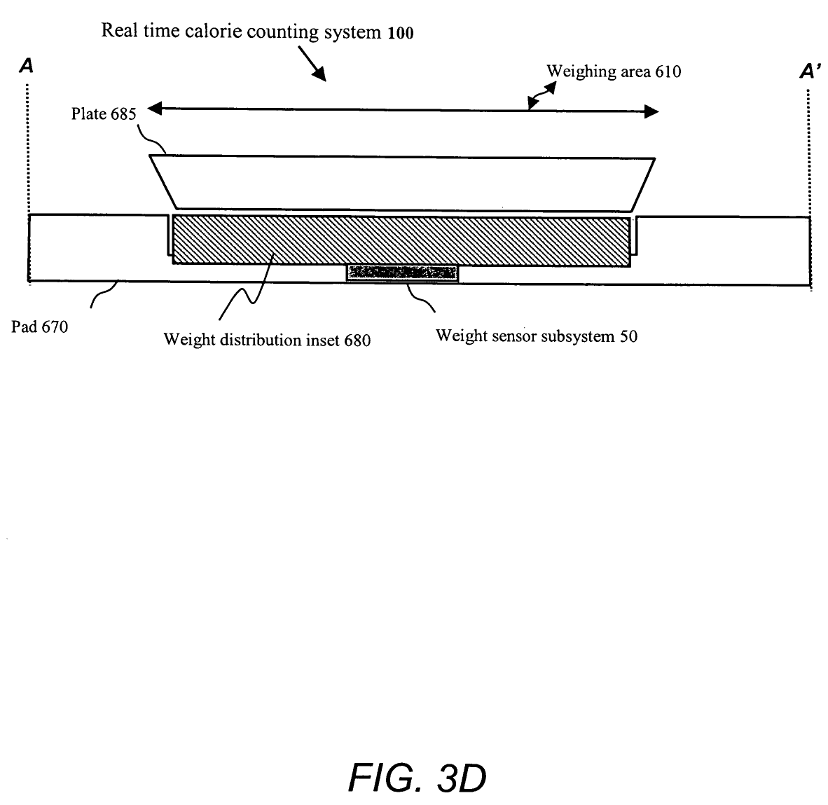

An individual can weigh food items or food containers, such as a plate, using weight sensor 50 (described in further detail in FIG. 3 below). The food items being weighed may be placed on weight sensor 50 individually or grouped together, such as an entire meal. The food items may be weighed prior to eating or while eating. Alternatively, the portions remaining after having eaten can be weighed. Weight sensor 50 may be powered by batteries or plugged in. Further detail on weight sensor 50 is found in FIG. 3 below.

Computer 60 is a computing device such as a personal computer (PC) or personal digital assistant (PDA) or a integrated computer in the overall real time calorie counting system 100 capable of executing software programs and storing data.

In operation, a user can determine the calorie content of a food item by placing the food item contained on or in a food container, such as a plate, on weight sensor 50. The weight of the food container may be weighed prior to placing the food item on it, or the weight of the food container may be stored on computer 60. The weight of the food item and food container is determined by weight sensor 50 and the weight measurement data is transmitted to computer 60. Computer 60 deducts the weight of the food container to determine the weight of the food item only. A user selects or inputs the name or type of food item into keyboard 80. Computer 60 receives the data input from keyboard 80, calculates the total calories in food item, and stores the data along with the time and date. Computer transmits the information to display 70 for the user to see the information.

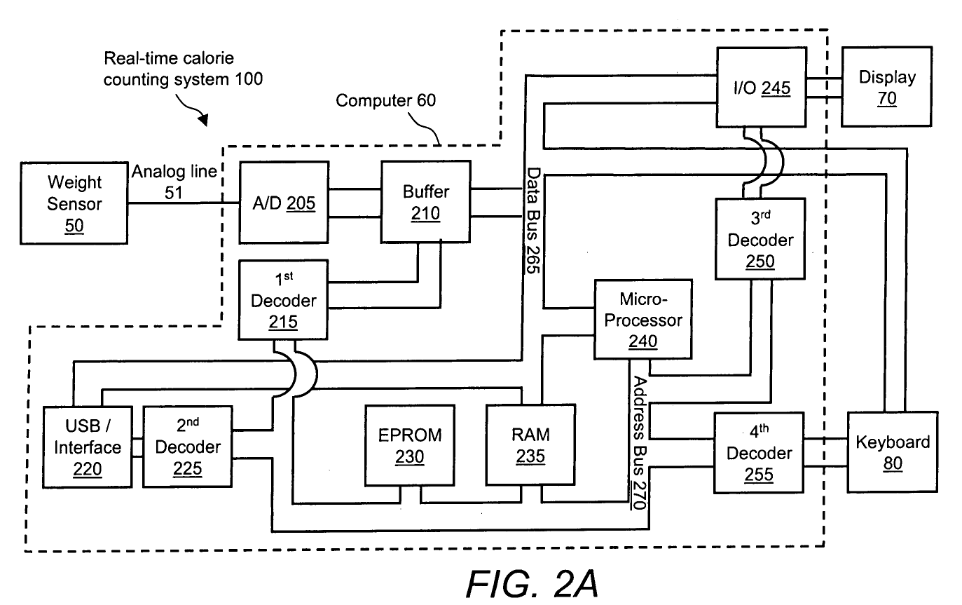

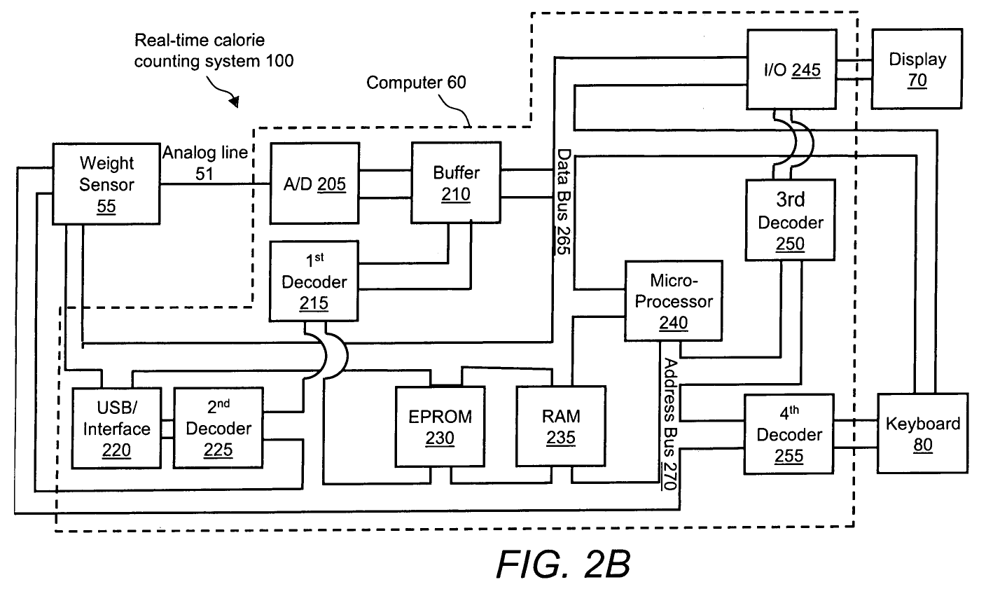

FIG. 2A is a detailed functional block diagram of real-time calorie counting system 100. Real-time calorie counting system 100 further includes weight sensor 50, display 70, a keyboard 80, a computer 60, which further includes an analog-to-digital (A/D) converter 205, a buffer 210, a decoder 215, a universal serial bus (USB) 220, an input-output (I/O) device 225, an electrical programmable read-only memory (EPROM) 230, a random access memory (RAM) device 235, a microprocessor 240, an I/O 245, a decoder 250, a decoder 255, a data bus 265, and an address bus 270.

The functional blocks of real-time calorie counting system 100 are connected as shown in FIG. 2A.

In general, microprocessor 240 controls the operation of real time calorie counting system 100 (system 100). Software instructions programs (not shown) are stored in EPROM 230. Data that is obtained in system 100 is stored in the RAM 235. In general, microprocessor 240 sends address data on the address bus 270 to all devices connected to address bus 270. Only those devices that decode their specific addresses are initialized. In general, all data goes to and from microprocessor 240 using the data bus 265. Only those devices that are activated by the addressing of the device can send data to the microprocessor 240 and receive data from the microprocessor 240.

Display 70 is a device, such as a CRT or LCD, which provides visual feedback to the user. Display 70 receives input from computer 60. Display 70 is interfaced to the data bus 265 through I/O 245. I/O 245 is any of a standard type of display drive devices that may include its own memory devices, its own decoders etc. The display 70 is addressed by address bus 270 through 3^{rd} decoder 250. I/O 245 is then available to be activated and allows data through data bus 265.

Keyboard 80 is a device, such as a keyboard, touch screen, buttons, etc., that allows a user to input data into real-time calorie counting system 100. Keyboard 80 provides data to computer 60. Keyboard 80 sends data to data bus 265 and hence to microprocessor 240 when the address accessing the keyboard 80 is made through 4^{th} decoder 255 connected to address bus 270, which connects to microprocessor 240.

EPROM 230 has its own internal decoder and microprocessor 240 accesses EPROM 230 through address bus 270 and then sends or receives data from microprocessor 240 through data bus 265.

RAM 235 has its own internal decoder and microprocessor 240 accesses RAM 235 through address bus 270 and then sends or receives data from microprocessor 240 through data bus 265. USB/interface 220 is an external connection to the microprocessor 240 to send or receive data to other computers or computer interfaces (not shown). USB/interface 220 sends or receives data to microprocessor 240 through data bus 265 when microprocessor 240 accesses USB/interface 220 though the 2^{nd} decoder 225 when the correct address is sent on address bus 270.

Computer 60 is capable of receiving weight data from weight sensor 50.

Weight sensor 50 continually sends out an analog signal on analog line 51 that represents the real time weight of the system using weight sensor 50. Analog to digital converter 205 converts the analog signal on analog line 51 to digital data using Analog to Digital converter (A/D) 205. The digital data is continually sampled and loaded onto buffer 210 though standard means whereby the buffer 210 samples the output of A/D 205. When the microprocessor 240 sends the correct address on address bus 270, 1^{st} decoder 215 decodes this correct address and then initializes buffer 210 to make the digital data representing the real time weight to data bus 265 to microprocessor 240.

In operation, real-time calorie counting system 100 is first programmed with data, including, but not limited to the calorie and other nutritional component content of various food items, user health profile (e.g. age, height, and weight), exercise data and other periods of energy expenditure, and diabetic blood glucose readings. The data may be downloaded to real-time calorie counting system 100 through USB 220 to microprocessor 240. The data is stored in RAM 235. To determine the calorie content of a food item, a user places the item on weight sensor 50. A user may select various modes of operation by using keyboard 80 to enter or select from a variety of options and modes, for example weigh food, “count as you eat”, and “enjoy your meal.” The options available and information entered may be displayed on display 70.

When an option or mode is selected whereby real-time calorie counting system 100 requires the weight of a food item, microprocessor 240 sends address information on address bus 270 requesting to communicate with weight sensor 50 that is received by decoder 215. Information and instructions are then able to be transferred between microprocessor 240 and weight sensor 50. A food item is weighed by weight sensor 50, and the weight data is converted from an analog signal to a digital signal by A/D 205. The data is buffered by buffer 210 and received by microprocessor 240.

FIG. 2B illustrates an alternate arrangement for the functional blocks of real-time calorie counting system 100, where multiple inputs are included in weight sensor 55 and require separate decoding, address, and data lines. In the alternate arrangement, everything is identical to FIG. 2A with the exception of added connections from data bus 265 and address bus 270 to weight sensor 55. This design and its operation are explained in detail below in FIG. 3B.

FIG. 3A illustrates the design of weight sensor 50, which is a pressure sensitive conductive ink force sensor system. Weight sensor 50 operates in a general range of 0 to 10 kg to accommodate the weight of a plate and a meal. Preferably, it has a resolution and accuracy better than 0.1 gr.

In one example, weight sensor 50 is illustrated by the Tekscan “FlexiForce” sensor system, which consists of an ultra-thin, flexible printed circuit to create a force sensor. The force sensors are constructed of at least two layers of substrate (e.g. polyester/polyimide) film. On each layer, a conductive material (silver) is applied, followed by a layer of pressure-sensitive ink. Adhesive is then used to laminate the two layers of substrate together to form the force sensor. The active sensing area is defined by the silver circle on top of the pressure-sensitive ink. Silver extends from the sensing area to the connectors at the other end of the sensor, forming the conductive leads. These sensors measure resistance, which is inversely proportional to force. The linearized force measurements are translated into weight measurements, for real-time calorie counting system 100. This design provides the needed form factor and flexibility required for the invention.

FIG. 3A, derived from U.S. Pat. No. 6,272,936 and incorporated by reference herein, shows an example of weight sensor 50, which may be used in real-time calorie counting system 100. All of the components of FIG. 3A are identical to U.S. Pat. No. 6,272,936 and works as described in the reference. Line 128 was added to be the analog voltage out or analog line 51 of FIG. 2A. Weight on sensor R1 102 of FIG. 3A causes a corresponding analog voltage on 128 of FIG. 3A and hence an analog voltage on analog line 51 of FIG. 2A.

It may be possible for capacitive pressure sensors to be used that change the frequency of a tuned circuit in response to applied pressure. Examples of such sensors are M100 Miniature Planar Beam Load Cell, stainless steel low profile sensors available with ratings of 1, 2, 5, pounds, and Mini Pressure Washer (g) Pressure Sensor, only ⅛ inch tall, these stainless steel pressure sensors come in a variety of pressure ratings from 10 to 2000 grams. Model M1025, Muse Measurements 276 E. Arrow Highway, San Dimas, Calif. 91773. However there are likely challenges in minimizing both the cost of the device and the thickness and flexibility of the pad in using this type of sensor and thus the piezoelectric solution is preferred.

As illustrated by weight sensor subsystem 55 in FIG. 3B, there exists a further expansion of weight sensor 50 provided through establishing a set of pressure sensitive sensors 120₁ through 120ₙ. These pressure sensitive sensors 120₁ through 120ₙ are judiciously designed in terms of amount of conductive ink and surface are of conductive ink to optimize the weight to resistance changes. So, for example, pressure sensitive sensor 120₁ could be a 5-10 lb weight response for a given resistance range, whereas pressure sensitive sensor 120₂ could be designed for a 2-5 lb weight change for a given resistance range, and pressure sensitive sensor 120₃ could be 1-2 lbs. for a given resistance change and pressure sensitive sensor 120₄ could be designed for 0 to 1 lb weight change for a given resistance change. Resistors 120ₙ are networked via switch matrix 310 to provide varied arrangements of resistance in series and/or parallel as required for varying load capacity. Because the load of weight sensor subsystem 55 real time calorie counting system 100 will vary significantly with the types and amounts of foods added, weight sensor subsystem 55 needs to accommodate this range of load dynamically and without loss of functionality.

The switch matrix 310 of FIG. 3B is designed to switch any of the pressure sensitive sensors 120₁ through 120ₙ into the circuit at points 20 and 26 through output connection 1^{st} Output 325 and 2^{nd} Output 330 respectively. The switch matrix 310 is controlled via decoder 320 through addressing it from address bus 270 of FIG. 2B and controlled in terms of how the pressure sensitive sensors 120₁ through 120ₙ are switched into the circuit when from data on data bus 265 of FIG. 2B.

“Vref In” 1 through n of FIG. 3B are switched to the VREF 106 of the circuit through connection of 3^{rd} Output 335. Reference voltages are needed to be switched as the pressure sensitive sensors 120₁ through 120ₙ are switched so that the operational amplifier 104 is optimized. Thus the dynamic range can be controlled as the Vref In 1 through n voltages, and the pressure sensitive sensors 120₁ through 120ₙ are changed and adapted in the circuit.

In operation, food is placed on real time calorie counting system 100 and activates weight sensor subsystem 55. The lowest range, smallest weight, highest sensitivity pressure sensitive sensors 120₁ through 120ₙ is the default setting before any weight is detected. As the weight is applied to the pressure sensor load via the lowest range sensor, the sensor is applied across 20 and 26 of the circuit to produce an analog output 128 of FIG. 3B to analog line 51 of FIG. 2B to A/D converter 205 to buffer 210 to microprocessor 240 via data bus 265.

Algorithms in EPROM 230 are used by microprocessor 240 to determine that the range detector is at the maximum range of the pressure sensor, and whether to switch to the next less sensitive sensor. If a switch between sensors and references voltages is required because the sensors are at the top or bottom of its range, the value of that sensor is stored in RAM 235. The microprocessor 240 then switches to the higher or lower pressure sensor by addressing the decoder 320, which then activates the switch matrix 310 through address bus 270, and then sends the data through the data bus 265 to the decoder 320. This action prompts switch matrix 310 to switch in the new pressure sensor or pressure sensors 120₁ through 120ₙ to adjust resistance and voltage references VREF In 1-n, output 325 and 2^{nd} output 330, and thus accurately measure the load being sensed by weight sensor subsystem 55.

By using the knowledge and data stored about what the last measurement was, in conjunction with the new sensor data in its range, the new total weight can be obtained with high sensitivity. In this manner the design of weight sensor subsystem 55 is able to accommodate and measure small loads, larger loads, and small or large changes in loads.

FIG. 3C illustrates a top down view of real time calorie counting system 100, made in accordance with the present invention. Real time calorie counting system 100 includes weighing area 610, display region 70 that is of the touch screen type that further having mode selection buttons regions 630, food selection data regions 640, summary data regions 650 and process selection buttons regions 660.

Weighing area 610 is the area where the plate is positioned.

Mode selection buttons regions 630 allow the user to select “Overall Mode”, “Enjoy your meal”, “calculate calorie content”, “count” as you eat” and “ENTER selected mode”. In these regions, the user can touch the display regions and provide input data to the system.

Process selection buttons regions 660 provide operation of real time calorie counting system 100 include “Tare container”, “Weigh Food”, Remove Food” and “Meal Complete”. In these regions, the user can touch the display regions and provide input data to the system.

Food selection Data region 640 provide a means for selecting food types. Optionally, the food selection screen may include the specific nutritive content of the food, for example, if calories are being monitored, “Broccoli 7.2 cal/gr”, Mashed Potatoes 15.0 Cal/gr”, Chicken 12.0 Cal/gr and “More”. “. In these regions, the user can touch the display regions and provide input data to the system. The “More” button allows the user to select other choices.

The summary data region 650 shows resulting data “Target: 600 CAL”, “This meal: 312 cal”, balance 228, Daily TBD”. In this region the resultant data “target: 600 cal” is calculated from the target calories per day inputted by the user, where as the “This meal: 312” and “balance: 228”, Daily: TBD” is calculated from the calories determined from the weight of the present meal (312 calories) minus the inputted target 600 calories leaving 228 calories

The other data in display region 70 is status information data such as “Current Food name”, Meal tracking”, “date (Jul. 7, 2005) and time (12:17 pm)” and “summary info”.

In operation, for example, mode selection button regions 630 and process selection regions 660 permit selection of food names for multiple meal selections.

In an alternate embodiment, real time calorie counting system 100 may be linked to a separate PDA device (not shown) via USB region 699 that relates to USB 220 of FIGS. 2A and 2B. The real time calorie counting system 100 may link to other computers or storage devices to allow external control of the real time calorie counter 100 of FIG. 1 or simply to load in the food type, weight, or calorie database.

Cross section A-A′ is further described in FIG. 3D and is a cross section through the real time calorie counter 100 of FIG. 3C.

FIG. 3D shows a cross section A-A′ of real time calorie counting system 100, which includes weighing area 610 that describes the identical weighing area of 610 of FIG. 3C, pad 670, a weight distribution inset 680, a plate 685, and weight sensor 50. In general, pad 670 is water-resistant and easy to clean, flexible material such as foam rubber. Weight distribution inset 680 is made of a hard semi-rigid plastic. Weight sensor 50 is the physical representation of the weight sensor 50 of FIG. 1, and FIG. 2A and also weight sensor 55 of FIG. 2B.

Pad 670 is a flexible material, such as foam rubber, that provides support yet is still compact and can be rolled into a cylinder for use of storing in a small space. Weight distribution inset 680 provides a degree of rigidity and support to weighing area 610, which is needed to help more evenly distribute the force and thus the measured weight across plate 685. Weight sensor 50 is located underneath the center of weight distribution inset 680 to measure at the most central point under real time calorie monitoring system 100.

The real time calorie counting system 100 may operate independently of an external computer at the time of food consumption. In this case, the real time calorie counting system 100 has memory of the food identification (names entered by a keyboard or keyboard simulation) and the final weights of foods consumed. Memory is adequate for many days of such data. The information is downloaded when convenient for management by a computer based software program with internet connectivity. A real time calorie counting system 100 having full food table capabilities and computer power is also easily envisioned.

Real time calorie counting system 100 can be embodied in a variety of formats. This reflects the possibility of separating a) weighing functions, b) food identity inputting, c) lookup of stored specific energy of the identified food, d) storage of meal data, and e) downloading and up loading of data to internet sites.

The embodiments can be of a variety of system designs.
i. One Piece: a self-contained device format has weighing capability, and processing functions. It operates independently.
ii. Separate Weighing Modules: A weighing module can be used portably storing food identities and weighing data. It would be connected to a processing module once a day or once every few days to down load food portion weights and food identities as a function of data and time. The processing module could service any combination of multiple users and multiple weighing modules when the weighing modules are connected to the processing module.
iii. Multiple Weighing Modules with Single Processing Module: A processing module could service multiple weighing modules simultaneously. For example, a family can have a meal together with each member of the family having their own weighing module. The processing module can inform each weighing module of the real time consumption level and target gaps.

Conventional plates may be used even when multiple foods are on the single plate or a novel multi-compartment plate may output weight for three or four demarked food areas.

In another example the pad itself can be a washable and segmented plate that has sections for different foods. Each section has its own weighing mechanism regions on pressure sensors. The design of weight sensor 50 in this case is modified to manage separate regions of the washable, segmented plate and report specifically on food weight, calorie content, and consumption per each segment.

Modules can be connected by USB/interface connection 220 of FIGS. 2A and 2B or wirelessly connected (not shown). Microprocessors 240 of FIGS. 2A and 2B can analyze individual dietary information and analyze family dietary patterns, as well. The latter exemplified by a question such as “what foods are associated with the family exceeding their calorie consumption targets?”

Method of Operation of Real Time Calorie Counting System

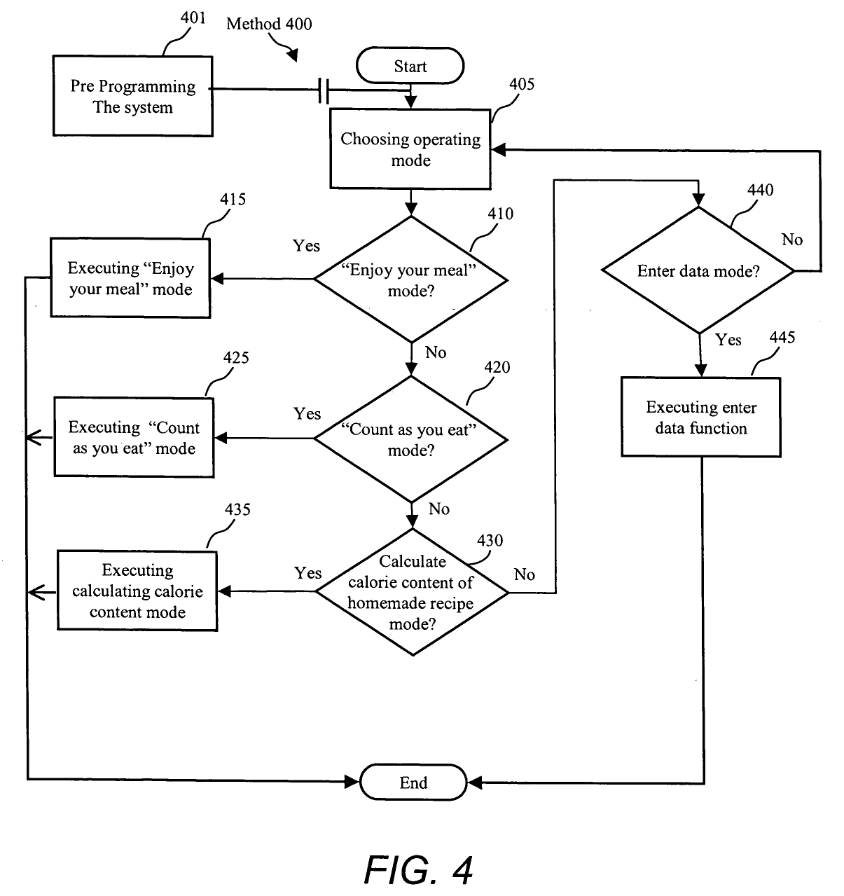

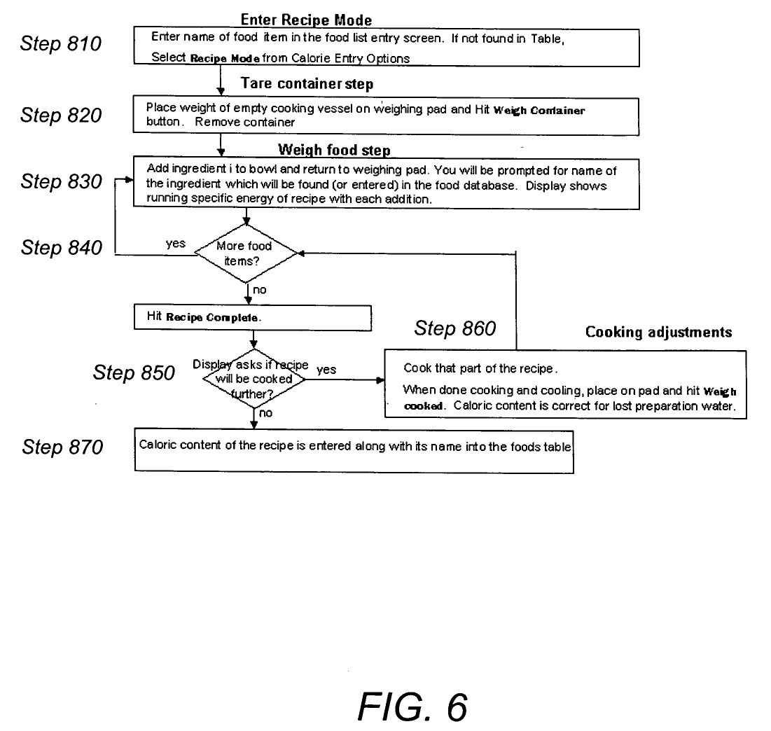

FIG. 4 illustrates a flow diagram of a method 400 for operating real-time calorie counting system 100. These functions are included as possible PDA functions of real-time calorie counting system 100, and shown in FIG. 6A below.

Step 401: Pre Programming the System

In this step, the system is pre-loaded with its operating software in EPROM 230. Also, data tables are programmed into EPROM 230 that relate food type to weight to calories. See example Table 1 below of a possible data structure to be programmed into EPROM 230.

TABLE 1
Exemplary data structure for food and nutritive content table

| | | | | Additional |
|---|---|---|---|---|
| | | | | columns of |
| | | | Calories for | specific |
| | Specific Calories | Typical Serving | typical serving | nutritive |
| Food Item | per ounce | Size | size | composition |
| Chicken breast, | 55 | 3 ounces | 165 | |
| meat & skin, | | | | |
| roasted | | | | |
| Taco Supreme | 65 | 4 ounces | 260 | |
| (Taco Bell) | | | | |
| Broccoli | 3.75 | 4 ounces | 15 | |
| Bread, Garlic | 120 | 1 oz slice | 120 | |
| Coffee cake | 150 | 2 oz slice | 300 | |

Also in this step, the user is also prompted for data to store in EPROM 230 such as target calories per day, per meal, and optionally health data such as beginning weight, target weight, metabolism information, etc. Software includes an interface to allow upgrading the database, addition of user specified food choices, and editing the database.

Step 405: Choosing Operating Mode

In this step, computer 60 executes software in EPROM 230 that displays a message on display 70 prompting a user to select an operating mode. To calculate the energy of the food intake, the user selects a weighing mode from “Enjoy your meal” or “Count as you eat” calculation options.

The user is prompted to “Tare weight the container or plate” where the user places the container on pad region and enable “weigh container” function;

The method 400 proceeds to step 410 where the user is first prompted with the “Enjoy your meal” mode.

Step 410: Enjoy your Meal Mode

In this decision step, using keyboard 80, a user chooses whether to enter this operating mode. If the user selects this operating mode, method 400 proceeds to step 415. If the user does not select this operating mode, method 400 proceeds to step 420.

Step 415: Executing Enjoy your Meal Function

In this step, software stored on EPROM 230 is executed allowing a user to determine the caloric content of a food item, or group of food items, using real-time calorie counting system 100.

The “enjoy your meal mode” programmed into EPROM 230 includes the steps of:
(1) Weigh food—Enable weight sensor 50. In this step the total weight is measured, the tare of the container is subtracted to allow the system to calculate the real time exact measurement of the food added.
(2) Identify food—The user is prompted to enter the name of the food item from the list of prestored food types in the data stored in EPROM 230. The user picks from the list to select from a pre-defined list. The user selects from that list or enters a new food profile. Alternatively, a bar code reader can be coupled to the EPROM 230 so that a food package can be scanned to automatically bring up the identified food;
(3) Add food, the user adds the food to the plate
(4) Calculate the calories—as the food is added, the weight is obtained and converted to the calories by simply looking up the food type selected in the data table in EPROM 230 of FIG. 2A, using the identified weight and calorie data to determine the ratio and using this ratio to multiple by the weight found to calculate the total real time calories. Once the food type is loaded on the plate, the total calories are stored.

Example: The user selects “Chicken breast, meat & skin, roasted” from the list. The identified weight via weight sensor subsystem 55 is 5.5 ounces. The calories are calculated by looking up the calorie content in data tables contained in EPROM 230 and multiplying that factor by the weight of the food item as shown below:
5.5 ounces of chicken*(165 calories/3 ounce serving)=302.5 calories

Display 70 will then show as one of the selected and loaded foods, “Chicken—302.5 cal.” The user may now select a different food type, and then start adding food to the plate and the real time calorie counting system 100 of FIG. 1 looks up the new food type in the data table stored in EPROM 230 of FIG. 2A or FIG. 2B and uses the new added weight and the ratio to calculate the added calories.
(5) Understanding the portion size where the Display 70 shows calories for all individual food items and total calories on plate. Target calories for this meal and the overall day can be shown as well;
(6) Adjust portion sizes—During the meal, the user may remove a food from the plate and adjust the portion size using the real time calorie counter 100 of FIG. 1 to recalculate the total calories.
(7) Store meal data—When completed with meal, enter “meal completed” to store information and move to ready mode.

Note that as an alternate approach, the name and amounts of food eaten during the day may be entered therein for later lookup of the caloric content. This type of device would then be used to only store the name and weights consumed for full calculations done later when connected to another computing unit containing the food items lookup tables. As memory capacity of portable equipment increases this becomes less necessary. Method 400 ends.

Step 420: Count as you Eat Mode?

In this decision step, using keyboard 80, a user chooses whether to enter this operating mode. If the user selects this operating mode, method 400 proceeds to step 425. If the user does not select this operating mode, method 400 proceeds to step 430.

Step 425: Executing Count as you Eat Function

In this step, software stored on EPROM 230 is executed allowing a user to determine the calories of a meal as they eat using real-time calorie counting system 100. In the “count as you eat” mode calculation, the weight is based on assigning the currently collected weight difference to the current food item selected. To input the identity of the food in the “count as you eat” mode, the software requests the identity of food. The user begins by selecting the food type in food data selection region 640 of FIG. 3C. The user may select the food and weigh it, subsequently the software will calculate and show the caloric content using the same process as Step 415 above.

The user selects the food type, eats as much as desired, selects a new food type, and eats that food, and so on. The weight change since the last food type selection is assumed to be added weight consumed of that food, added to a running sum of that food's intake; caloric intake is the sum over all foods of the running sum of each food consumed weight times its specific energy. Method 400 ends.

Step 430: Calculate Caloric Content of Homemade Recipe Mode?

In this decision step, using keyboard 80, a user chooses whether to enter this operating mode. If the user selects this operating mode, method 400 proceeds to step 435. If the user does not select this operating mode, method 400 proceeds to step 440.

Step 435: Executing Calculate Caloric Content of Homemade Recipe Function

In this step, software stored on EPROM 230 is executed allowing a user to determine the calories of a home cooked food item using real-time calorie counting system 100. This method is described in detail in FIG. 6. Method 400 ends by proceeding to Method 800.

Step 440: Enter Data Mode?

In this decision step, using keyboard 80, a user chooses whether to enter this operating mode. If the user selects this operating mode, method 400 proceeds to step 445. If the user does not select this operating mode, method 400 proceeds to step 405.

Step 445: Executing Enter Data Function

In this step, software stored on EPROM 230 is executed allowing a user to enter names, calorie information, and other data of food items into real-time calorie counting system 100 for storage on RAM 235. Method 400 ends.

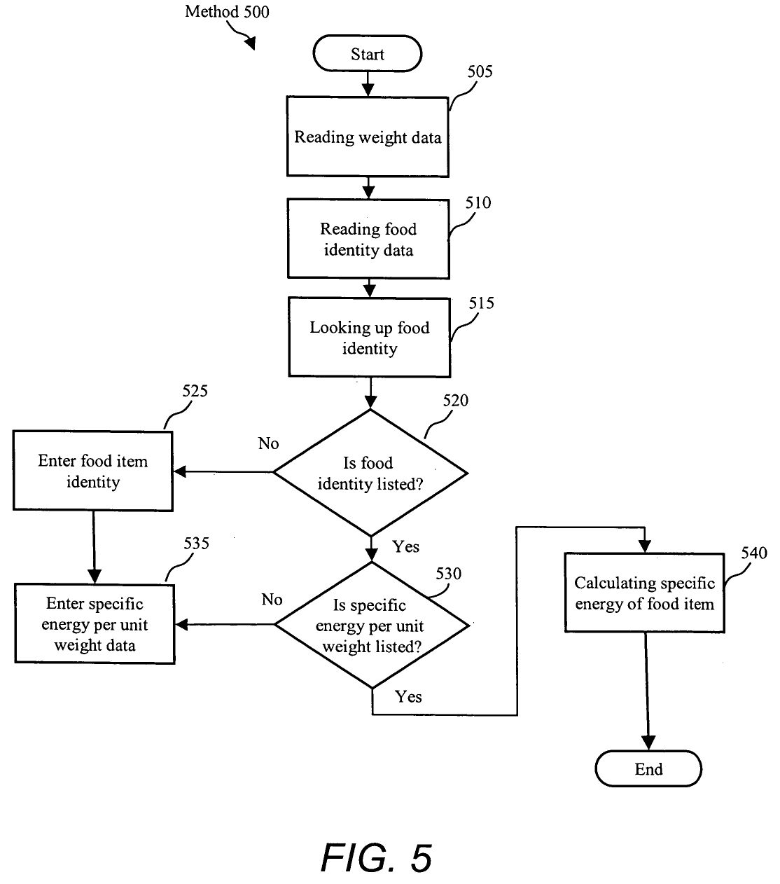

FIG. 5 illustrates a flow diagram of a method 500 for calculating the caloric content of a food item and includes the steps of:

Step 505: Reading Weight Data

In this step, microprocessor 240 reads weight data from a memory device, such as RAM 235. Weight data may be of a food item just weighed by weight sensor 50, or it may be data of a previously weighed or entered food item stored in RAM 235. Method 500 proceeds to step 510.

Step 510: Reading Food Item Data

In this step, microprocessor 240 reads food item data from a memory device, such as RAM 235. User enters or selects food item with keyboard 80 based on information displayed on display 70. Food item selection is stored in RAM 235. Method 500 proceeds to step 510.

Step 515: Looking up Food Item

In this step, microprocessor 240 reads database stored in RAM 235, searching for food item selected in step 510. Food identifiers and their specific energy are contained in the database, which may be provided with the real time calorie counting system 100 upon purchase, and further the content of RAM 235 may be updated over the Internet (or directly by the user in Step 525 below). Users and food manufacturers may upload new food profiles for the database at the Internet site where these may be downloaded as timed updates, e.g., “new items contributed since last update done Mar. 14, 2005.”

Calories for conventional food units (e.g., rye bread . . . one slice . . . 60 calories) may be entered or looked up. If entered, the value can be stored by the user in RAM 235 for future selection. The database information includes, at a minimum, caloric content listings (e.g., rye bread . . . 5.4 kcal/gr) can further provide addition dietary information, such as fat content per unit weight, sodium content, etc. When the caloric content is known, calculation of energy intake requires measuring the weight of that food consumed.

The database in RAM 235 is arranged for convenient hierarchical categorical or alphabetic selection by the user or rapid matching to input information. Method 500 proceeds to step 520.

Step 520: Food Item Listed?

In this decision step, microprocessor determines if food-item selected in step 510 is listed in database stored in RAM 235. If food item is not found in the database, method 500 proceeds to step 525. If food item is found in the database, method 500 proceeds to step 530.

Step 525: Enter Food Item

In this step, a user is prompted by display 70 to enter the name of food item. Information is entered using keyboard 80. When a new food is entered, a caloric content calculation page allows filling in blanks to determine the caloric content of a food using any available labeling information. New food items may be added to the database by the user via multiple sources, including but not limited to food nutrition label information, a supported recipe function, or a mail in calorimetric service. If the calories per gram is on the label that may be entered and the calculator immediately concludes with the result displayed. If calories per portion field are filled in, fields for number of portions per container and weight of container are highlighted. Method 500 proceeds to step 535.

Step 530: Specific Energy Per Unit Weight Listed?

In this decision step, microprocessor determines if the specific energy per unit weight of food item is listed in database stored in RAM 235. If specific energy data is not found in the database, method 500 proceeds to step 535. If specific energy data is found in the database, method 500 proceeds to step 540.

Step 535: Enter Specific Energy Per Unit Weight Data

In this decision step, a user is prompted by display 70 to enter the specific energy per unit weight of food item. The result display prompts whether the new food information should be added to the food database and in any case, the specific energy (caloric content) is displayed on the display. The display contains a section that supports entering the calories for a portion of food, weighing that portion and entering the resulting caloric content for the database. Information is entered using keyboard 80. Method 500 proceeds to step 540.

Step 540: Calculating Specific Energy of Food Item

In this step, microprocessor 240 multiplies the specific energy per unit weight of food item by the total weight of food item to determine the total caloric content of food item. Results are stored in RAM 235. Method 500 ends.

FIG. 6 illustrates a method of calculating caloric content (specific energy) of a homemade recipe, and includes the steps of: Step 810: Enter recipe mode, Step 820: tare container, Step 830: weigh food, Step 840: Are there more food items? Step 850: Does the recipe require further cooking? Step 860: Calculating cooking adjustments and Step 870: Entering recipe content into foods table.

When preparing food, the dish may be made from ingredients with caloric content known by the computer. Then the component fractions may be estimated or measured while the ingredients are added to the preparation bowl which is being weighed by the device. The device may then properly calculate the caloric content of the resultant mixture and final (cooked or otherwise processed) foodstuff. The final value for the prepared food may be stored within the database for future lookup functions.

The specific energy (SE) of a home-made food item, whether cooked, mixed, or constructed is entered with the aid of real time calorie. counter 100 of FIG. 1. The user cooking food to determine the final calorie count would use the following method listed in FIG. 6.

For items put together without enough cooking to lose water, the algorithm determines the weight averaged energy content for the final food product by weighing each component minus its container (the measuring spoon or cup or a tray or wrap) and entering the energy content of the ingredient from the food list. Any water added must be included as a weighed component.
SE=Sum (WiEi)/Sum (Wi)

If the item is cooked, the specific energy is corrected for the lost moisture of the cooking process. Any loss of energy by the burning of ingredients is minor and ignored.
SEc=Sum (WiEi)/Wc

Where SEc, the cooked energy content can also equivalently be expressed as uncooked SE×(Sum (Wi)/Wc), where Wc is the cooked weight.

The program stores the food identities for the meal, the calories of each food consumed, and the calories for the meal. This data is available for transfer to a weight management program that compares the energy intake and the energy utilization over time and identifies opportunities for particular food substitutions, showing how many calories per month would be saved by the recommended substitutions.

The advantages over prior art of the above described device and method are numerous, including: (i) no current food scales keep track of calories consumed for multiple food on a real-time basis; (ii) no current food scales provide a way to keep track of different foods all on the same plate; (iii) no current food scales correct for uneaten portions; (iv) no calorie counting system takes the weight of a food from a sensor and calculates the weight of food consumed and multiplies this by the caloric content of the food; (v) no current food databases display calories per unit weight to support weighing of food. There are no inventions addressing the need to determine the caloric content of a food.

Business Methods for Real Time Calorie Counting

In addition a method of doing business is provided herein. Consumers, manufacturers, or restaurateurs may weigh a new food item into a capsule and send it to a service company who will return the caloric content for that item. To determine the caloric content of any new food item, gross energy content by adiabatic bomb calorimetry is typically the industry standard. The total potential energy of foods and food components is determined by burning the food sample in a steel bomb calorimeter under elevated oxygen pressure. An initially weighed sample is sent in, dried to eliminate water, crumbled for fast combustion, burned (typically in an oxygen atmosphere), and the heat released into all combustion products and surrounding materials measured by calibration of the surrounding temperature rise and correcting for ignition thermal input. The kilocalorie (1,000 calories) is the unit commonly used in expressing energy values of a defined quantity of foods.

A simple business method in support of this process consists of the following steps:
(1) User (customer, restaurant owner, etc.) identifying a new food that requires a calorie per weight measurement;
(2) Finding a service provider of bomb calorimetry for meal planning;
(3) Sending food sample to service provider for analysis;
(4) Receiving information back from service provider; and
(5) Paying service provider for information received from analysis.

Restaurants may list the caloric content (kcal/gr) of their rapidly changing offerings in addition to the less specific kcal/portion, which is inaccurate if your portion is larger than the one assumed or if you partake of less than the so-called full portion. The device and disposable samplers are sold to restaurants so that the caloric content of meals may be provided, where required by law, while retaining the menu flexibility characteristic of a fine dining establishment. With increasing popularity of the device, restaurants and food providers may provide ID tags with their food so that the food identity may be entered by bar-scan code, RFID tag technology, or other similar product identity coding system permitting fast table lookup, encoding of relevant information, or fast downloading of the caloric content.

Current weight management programs may monitor caloric expenditure using the devices and methods mentioned above. Programs could employ patient input of food consumption. The patient input is notoriously inaccurate if not biased as to portion size. This new method replaces this input mode with measured weight of food consumed for far more accurate tracking of calories consumed. No current system provides accurate timing of caloric intake. In the count as you eat mode, the meter provides accurate timing of caloric intake. This could be used as an input for an appropriate insulin pump algorithm. The above described device and method allows users to control food portions by displaying in real time the calories plated or consumed so that a dieter may take a smaller portion or stop eating to limit caloric intake near to or below desired targets. The device may drive the delivery of insulin from a pump with signals, short of a continuous glucose sensor, from the above device based upon caloric intake.

### Added Embodiments

In alternate embodiments that can be designed by one skilled in the art, data collected by real time calorie counter system 100 can be integrated with other weight management data for further analysis and user benefit. Examples of other weight management data include duration of periods of exercise, resultant calorie expenditure, markers of fat-burning metabolism, subject weight, and expected/calculated relationships among these.

For diabetic patients, a modification of real time calorie counter system 100 integrates data acquisition related to food intake such as calorie or carbohydrate intake data with an instrument that records blood glucose (BG) readings either by chemical analysis of blood samples or indirect readings that correlate with BG. Exercise history and plans can also be data incorporated for development of personalized insulin adjustment programs. Various readouts of food consumption history as well as current BG would advise the diabetic patient on adjustments to insulin dosage or pump delivery to achieve better management of glycemia. Algorithms to adjust insulin based on food intake data exist. An example of such a plan is adjusting 1U of insulin for every extra 15 gr or carbohydrates consumed (http://www.uchsc.edu/misc/diabetes/udchap21.html, table 3). Recording insulin administration and excecise further enhances the relationships that can be analyzed based on the stored data of the system. The data can be used to determine and individuals BG sensitivity to insulin and food intake to develop personalized algorithms aimed at better control of BG within normal ranges. These functions, such as analyzing blood glucose, currently exist in off the shelf products and could be integrated into a system design for the real time calorie counter system 100. For example, using a simple time and date stamp feature in computer 60, periods of glucose imbalance or weight gain may be identified and correlated with the meals and food categories involved in these periods of time. This information can be provided to the user or to a medical professional for assistance. The data on meal composition and caloric intake patterns provided by real time calorie counter system 100 may be uploaded to the real time calorie counter 100 of FIG. 1 to a centralized processing location (not shown) for advanced analyses, or communication in summary form to a participating physician or health care professional. The data may be downloaded, merged with other sensor information, or used in conjunction with symptom logs for support of disease management or wellness program functions. These may be used to make a range of personalized suggestions to improve desired outcomes based on the specific records of intake, exercise, drug dosage, and results recorded for the subject.

The real time calorie counter system 100 of FIG. 1 and associated methods of use offer numerous consumer benefits. Users can view the caloric content of food eaten taking actual portions into consideration. Often consumers are making wise food choices, but need feedback on the portions they are consuming. As an example, should a user want to add a pat of butter to a food, within the context of the real time calorie counter system 100, the user selects “butter” as a new food, adds butter to the plate, and reads the calories of the amount of butter added via display 70. The consequence of the actual portion size is immediately displayed for viewing. This is the only way that a user may discover the standard portion is much less than what they are used to consuming. A key advantage of the real time calorie counter system 100 is that it replaces misconceptions and fabrications with hard data.

While the present invention has been illustrated by description of several embodiments, it is not the intention of the applicant to restrict or limit the spirit and scope of the appended claims to such detail. Numerous variations, changes, and substitutions will occur to those skilled in the art without departing from the scope of the invention. Moreover, the structure of each element associated with the present invention can be alternatively described as a means for providing the function performed by the element. Accordingly, it is intended that the invention be limited only by the spirit and scope of the appended claims.

What is claimed is:

1. A method for monitoring dietary caloric intake of food items, said method comprising:
a. selecting a portion of food;
b. weighing said portion and importing the value into a computer;
c. inputting the type of said food into a computer; and
d. obtaining the caloric content of said food by from a database.
e. Using the computer to calculate the caloric intake from the inputs.

2. The method of claim 1 further comprising the step of displaying and storing said caloric intake on said computer.

3. An apparatus for monitoring dietary caloric intake of food items, said apparatus comprising:
a. means for weighing a preselected portion of food;
b. a computer for inputting the type and weight amount of said food therein; and
c. a database operatively associated with said computer for obtaining the caloric content of said food.

4. The apparatus of claim 3 further comprising a means for displaying and storing said caloric content on said computer.

5. The method of claim 1 further comprising a step to correct portions size by determining an amount left unconsumed.

6. The apparatus of claim 3 further including a display to show an amount of food consumed in real time.

7. The apparatus of claim 3 further including a bar code reader for inputting the type and weight amount of said food therein.
